(19) United States
(12) Patent Application Publication
(10) Pub. No.: US 2007/0205907 A1
(43) Pub. Date: Sep. 6, 2007

(54) Switch assembly and system for high-level monitoring

(75) Inventor: William P. Schenk JR., Rockford, TN (US)

Correspondence Address: REINHART BOERNER VAN DEUREN P.C., 2215 PERRYGREEN WAY, ROCKFORD, IL, 61107, US

(73) Assignee: Robertshaw Controls Company, Richmond, VA (US)

(21) Appl. No.: 11/367,894

(22) Filed: Mar. 3, 2006

(51) Int. Cl. G08B 21/00

(52) U.S. Cl. 340/623

(57) ABSTRACT

A level monitoring system for a floating roof tank is provided. The level monitoring system includes a switch electrically connected to a monitor. When the tank reaches a high fill level, the switch closes an electrical circuit. The monitor senses that the circuit has become closed, indicating the high fill level, and sends a signal to an alarm module. The level monitoring system may use either a cable pull switch or a tilt switch that are activated by the floating roof of the tank when the a predetermined level has been reached.

### FIELD OF THE INVENTION

This invention generally relates to monitoring apparatus for fluid storage tanks, and more particularly, to monitoring apparatus for storage tanks having floating roofs.

### BACKGROUND OF THE INVENTION

Many forms of bulk storage exist in today's industrial landscape for storing large quantities of liquids. One particular type of bulk storage is a floating roof storage tank. A floating roof storage tank has a roof, also referred to as a pontoon or deck, that floats on and is supported by the stored liquid. Thus, the roof rises and falls with the liquid level inside the tank. Furthermore, the roof is equipped with a closure seal or seals to close the space between the edge of the roof and a tank wall.

These types of tanks are typically used when it is advantageous to eliminate or reduce the amount of vapor stored between the top of the liquid and the bottom of the roof. Floating roof tanks are considered a safety requirement as well as a pollution prevention measure for many industries, including petroleum refining.

It is very important to provide a monitor to sense the when a high fill level of the tank has been achieved to prevent overfilling that may result in overflows or spills, particularly, because these tanks are often filled with hazardous materials. The monitor senses when this high fill level has been attained and sends a signal to an alarm module that warns appropriate personnel of this condition.

Many high-level monitoring systems for floating roof tanks will incorporate optical, ultrasonic, or pressure differential sensors. However, these can be very expensive and some of the sensors have been found to be unreliable. Furthermore, these sensors may draw more electricity than is preferable for battery operated applications because the optical sensor and ultrasonic sensor must be continuously or repetitively energized to determine if the high fill level has been attained thereby continually draining the battery's power supply. This makes these sensors undesirable for use with a tank that does not have a readily available power supply or tanks that store extremely flammable liquids.

There exists, therefore, a need in the art for a new and improved high level tank level monitoring system that operates on extremely low current levels that are required for battery operated monitors. The present invention provides such an improved high level tank level monitoring system.

### BRIEF SUMMARY OF THE INVENTION

In view of the above, the present invention provides a new and improved high level tank level monitoring system and method that overcomes the problems existing in the art. More particularly, the present invention provides a new and improved high-level tank level monitoring system for floating roof tanks that in an embodiment relies on mechanical switches.

In one embodiment, the high-level monitoring system comprises a switch, a counter load, and a monitor. The switch includes a biasing means for applying a first force on the switch to bias the switch to a first state. The counter load is operatively coupled to and adapted to be suspended from the switch. The counter load acts on the switch with a second force opposite the first force to bias the switch to a second state. The monitor is electrically connected to the switch. Furthermore, the second force is greater than the first force when the floating roof is below the high-level position, and wherein the first force is greater than the second force when the floating roof is at least equal to the high-level position.

In another embodiment, the high-level monitoring system comprises a monitor and a tilt switch assembly. The tilt switch assembly is operatively coupled to and adapted to be suspended from the monitor. The tilt switch has a housing that defines a pivot point at one end thereof and a switch positioned within the housing. The tilt switch assembly is in a first state when the floating roof is below the high-level position, and wherein the wherein the tilt switch is in a second state when the floating roof is at least equal to the high-level position.

In yet a further embodiment, the high-level monitoring system comprises a monitor, a body, suspension means, and a switch. The suspension means is coupled to the body for suspending the body above the floating roof. The body is movable between a first position where it is fully supported by the suspension means and a second position where it is not fully supported by the suspension means. The switch is electrically connected to the monitor. The switch is in a first state when the body is in the first position and in a second state when the body is in the second position.

In one embodiment of the present invention, the high level tank level monitoring system allows for both installation on new floating roof bulk storage tanks and retrofitting to an existing tank. Further, an embodiment of the present invention is particularly adapted to be usable with a tank that does not have a readily available power supply and with tanks that are used for storage of extremely flammable liquids. In a preferred embodiment, the monitor, such as that used in the assignee's “Centeron Wireless Tank Monitoring System” is wireless and battery operated as can be seen at http://wirelessmonitoring.centeron.net, although a wired interconnect is also acceptable. In such embodiments that are battery operated, the system of the present invention operates on extremely low current. Furthermore, the embodiment may use highly conductive electrical contacts such as gold.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a cross-sectional view of a floating roof tank having one embodiment of a high-level monitoring system constructed in accordance with the teachings of the present invention;

FIG. 2 is an enlarged simplified illustration of the high-level monitoring system of FIG. 1 wherein the high-level condition has not been reached;

FIG. 3 is an enlarged simplified illustration of the high-level monitoring system of FIG. 1 wherein the high-level condition has been reached;

FIG. 4 is an enlarged simplified illustration of an alternative embodiment of a high-level monitoring system constructed in accordance with the present invention using a tilt switch and wherein the high-level condition has not been reached;

FIG. 5 is an enlarged simplified illustration of the high-level monitoring system of FIG. 4 wherein the high-level condition has been reached;

FIG. 6 is a cross-sectional illustration of the tilt switch of the high-level monitoring system of FIG. 4 in an open condition; and

FIG. 7. is a cross-sectional illustration of the tilt switch of the high-level monitoring system of FIG. 4 in a closed condition.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

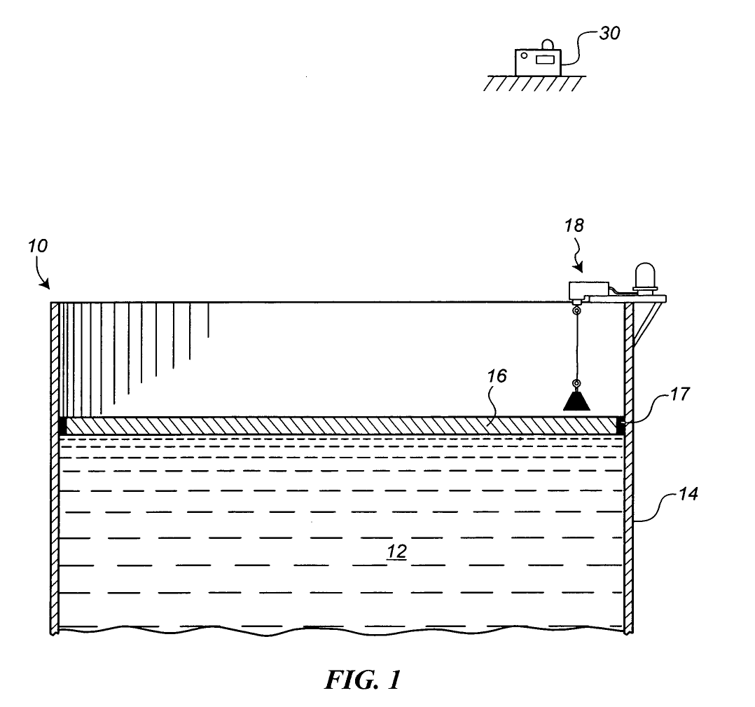

Referring to FIG. 1, a floating roof tank 10 (hereinafter referred to as “the tank”) for holding fluid 12 is illustrated. The tank 10 is an exemplary operating environment for a high-level monitor system according to the teachings of the present invention. The typical tank 10 includes a tank wall 14, a floating roof 16, also referred to as a pontoon or deck, a seal system 17, and a high-level monitor system 18. As the disclosed and described embodiments are referred to as “high-level” monitoring systems, one of skill in the art will understand that the present invention may be used for monitoring any tank level such as high, low, or any level in between. Therefore, the reference to a high-level monitor is not meant to limit the invention in any way to only high-level monitoring applications.

Typically, the tank wall 14 is cylindrical in shape, but it could take on other shapes, and has a smooth inner surface. The roof 16 floats on and is supported by the fluid 12 being stored in the tank 10. The seal system 17 prevents the fluid 12 or vapor from escaping between the tank wall 14 and roof 16 of the tank 10 while allowing the roof 16 to rise and fall relative to the tank wall 14 in response to a change in the fluid level. By floating directly on top of the fluid 12 stored in the tank 10, the roof 16 beneficially prevents a volume of vapor from being formed above the stored liquid 12. This is very beneficial when storing hazardous liquids that easily vaporize.

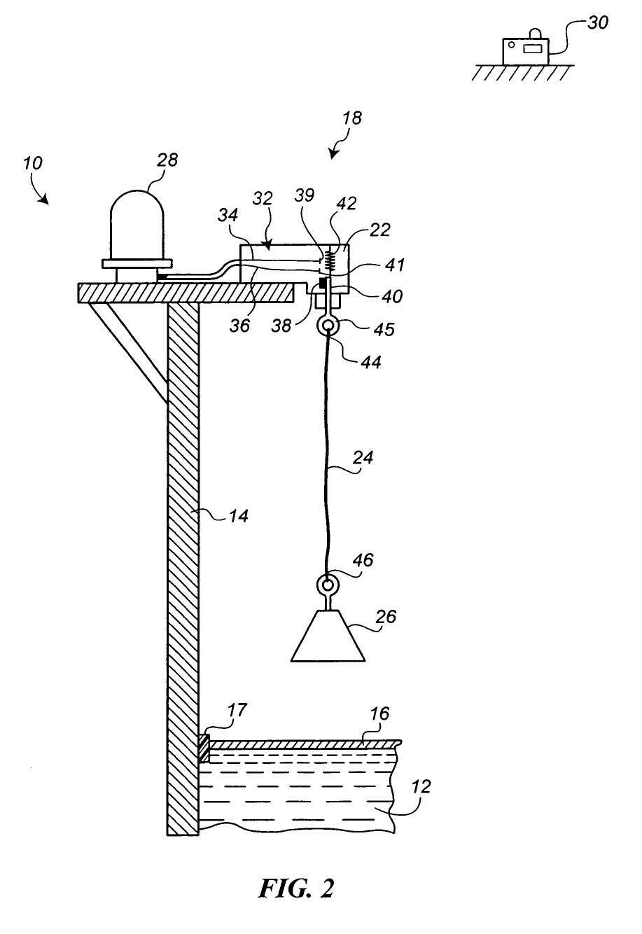

It is important to monitor the volume or level of the stored liquid 12 to prevent the tank 10 from overfilling, resulting in a spill-over or leaks. The point at which the tank 10 substantially reaches its preferred maximum capacity is referred to as the “high-level.” To prevent the tank 10 from being filled beyond the high-level, the tank 10 includes a high-level monitor system 18 that warns personnel that the tank 10 is reaching and/or has reached its maximum fill capacity. In an embodiment illustrated in FIG. 2, the high-level monitor system 18 includes a switch 22, a cable 24, a weight 26, a monitor 28 and an alarm module 30, which may be located remotely from the tank.

The switch 22 and monitor 28 provide an electrical circuit 32 for sensing when the high-level has been attained. The switch 22 operates to either open or close the circuit 32. Preferably, the high-level monitor system 18 operates with normally open logic such that the switch 22 is an open condition, thereby breaking the electrical circuit 32, when the high-level has not been reached. With the circuit 32 open, an electrical current cannot pass through the circuit 32. The monitor 28 reads this condition as indicating that the maximum fill level has not been reached.

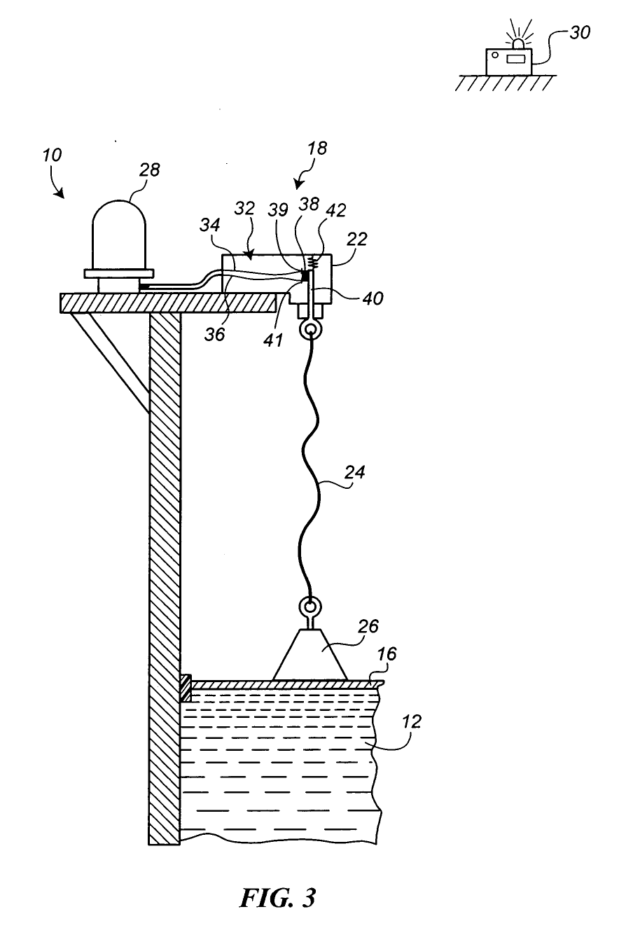

When the tank 10 is filled and reaches its high-level as shown in FIG. 3, the switch 22 moves to a closed condition, closing the electrical circuit 32 and allowing electrical current to pass through the circuit 32. The monitor 28 reads this closed condition as indicating that the tank 10 has reached its maximum capacity. Upon determining that the tank 10 has reached its high-level, the monitor 28 sends a signal to the alarm module 30 to inform personnel. The alarm module 30 may have an audible and/or a visual warning to alert control personnel. In one embodiment, the alarm module 30 may be integrated into the monitor 28. In an alternate embodiment, the monitor 28 is battery operated and wirelessly communicates with the alarm module 30. In another embodiment, the monitor 28 and/or alarm module 30 communicates with a computer or other control means (not shown) to automatically control the filling and/or emptying of the tank 10 as a result of attaining the maximum fill level.

Referring again to FIG. 2, the switch 22 and electrical circuit 32, shown in a simplified manner, include a positive lead 34 and a negative lead 36 that connect to the monitor 28. The switch 22 further includes an electrical contact 38 attached to an actuating shaft 40 to selectively electrically connect a positive electrical contact 39 of the positive lead 34 to a negative electrical contact 41 of the negative lead 36 to selectively open and close the circuit 32. In FIG. 2, the switch 22 is in an open condition and the electrical circuit 32 passing through the switch 22 is broken. With the circuit 32 broken, an electric signal sent from the monitor 28 may not pass through the circuit 32 indicating to the monitor 28 that the high-level has not been reached, as described previously.

To maintain the switch 22 in the open position, the cable 24 attached at a first end 44 to the head 45 of the actuating shaft 40 pulls and loads the actuating shaft 40 vertically downward. Having the actuating switch loaded in the downward direction, which extends from the top of the page to the bottom of the page, is merely for illustrative purposes and is not meant to limit the invention in any way. In other embodiments, the actuating shaft may be loaded in other directions other than vertically downward such as horizontally. A free swinging weight 26 attached to a second end 46 of the cable 24 provides the load that keeps the cable 24 taut when it is free swinging or not in contact with the roof 16. The cable 24 could be any rope, cable, chain, and the like or any other means of suspending the weight 26.

In FIG. 3, the switch 22 is illustrated in the closed condition. In the closed condition, the electrical contact 38 electrically connects the positive electrical contact 39 to the negative electrical contact 41 and, consequently, the positive lead 34 to the negative lead 36. Thus, with the circuit 32 completed, an electrical signal from the monitor 28 may pass through the switch 22 and circuit 32.

To move the switch 22 to the closed condition, a resilient biasing means 42 actuates the actuating shaft 40, and consequently the electrical contact 38 attached thereto, vertically upward thereby connecting the electrical contact 38 to the positive and negative electrical contacts 39, 41. The biasing means 42 applies a load opposite the cable 24, vertically upward, to actuate the actuating shaft 40 when the load of the weight is relieved from the cable 24, as shown in FIG. 3. Thus, the mass of the free hanging weight 26 must be large enough to overcome the force applied to the actuating shaft 40 by the biasing means 42 when the weight during the open condition. In an embodiment, the biasing means 42 is a coil spring

The type of switch used in this embodiment is referred to as normally closed. Without the external load, i.e. the weight 26, acting on the switch 22, the switch 22 would normally be closed. The high-level monitor according to the present invention, however, is not limited to using a normally closed switch. An embodiment may include a normally open switch. However, the circuit in this embodiment would work in the opposite manner as the circuit described previously with the normally closed embodiment.

In operation the free hanging weight 26 suspends above the roof 16 and loads the actuating shaft 40 of the switch 22 vertically downward, via the cable 24, to a downward position. In the downward position, the electrical contact 38 attached to the actuating shaft 40 does not complete the electrical circuit 32 and does not electrically connect the positive lead 34 to the negative lead 36. As the tank fills with fluid 12 and the fluid level rises raising the roof 16 supported by the fluid 12. At some predetermined fill level, the high-level, the roof 16 contacts and lifts the weight 26 relieving the cable 24 of the load provided by the weight 26. With the load relieved, the cable 24 becomes limp, as illustrated in FIG. 3.

In this position, with the weight 26 no longer acting on the cable 24, the biasing means 42 actuates the actuating shaft 40 vertically upward. With the actuating shaft 40 actuated vertically upward, the electrical contact 38 electrically connects the positive contact 39 to the negative contact 41 such that the switch 22 is in a closed condition and the electrical circuit 32 is completed. The monitor 28 reads that the circuit 32 is closed because a current passes through the switch 22. The monitor 28 sends a signal to the alarm module 30 or control means (not shown) that in turn warns personnel that the fluid 12 has reached the high-level.

In one embodiment the weight 26 is made of or surrounded by or coated with a material that prevents sparking when the weight 26 contacts the roof 16. In a preferred embodiment, the material is brass. This is particularly important when the apparatus is used with tanks that hold highly explosive or flammable fluids. In an embodiment where the monitor 28 is battery operated, the current passing through the circuit 32 from the monitor 28 may be extremely low. In this embodiment, the contacts between the positive and negative electrical contacts 39, 41 and the electrical contact 38 are of a highly conductive material. In a preferred embodiment, this material is gold.

Furthermore, other forms of a biased switch may be used, specifically, the structure that selectively connects the positive lead 34 to the negative lead 36. The actuating shaft 40 may merely pull or push the two leads apart during the open or closed conditions without requiring a separate electrical contact attached to the actuating shaft 40.

It is a benefit of the present invention that the high-level monitoring system 18 can be easily calibrated and/or adapted to tanks of various sizes by merely changing the length of the cable 24.

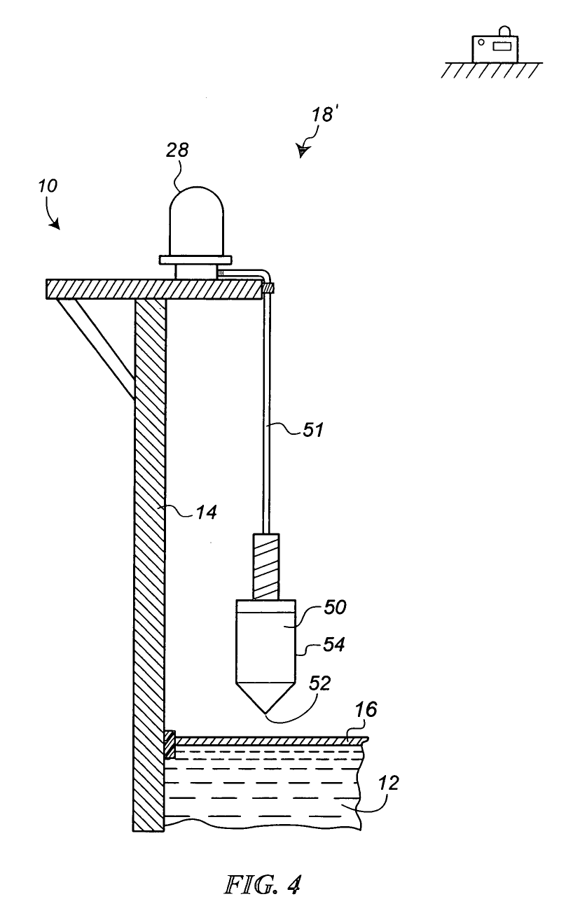

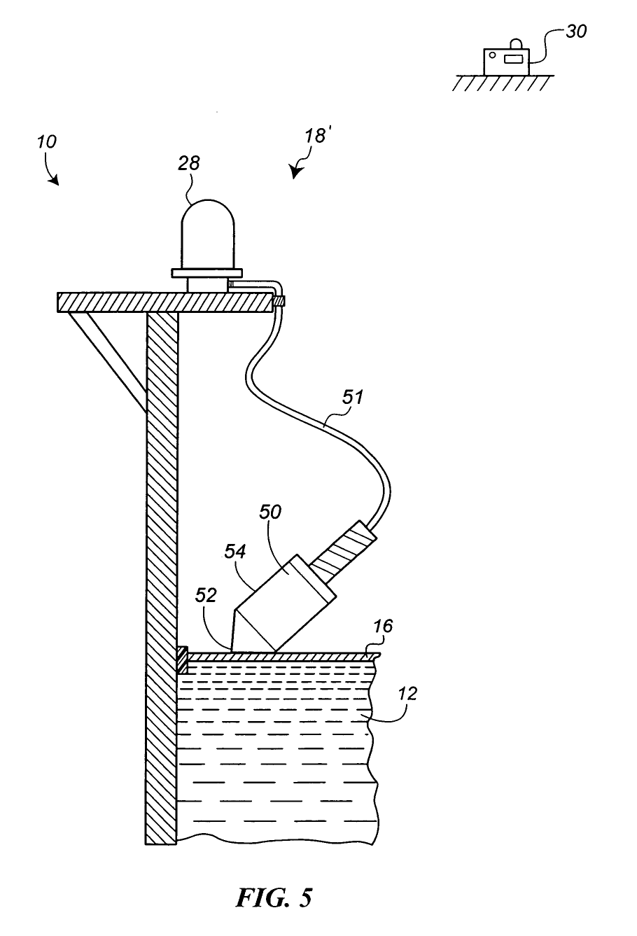

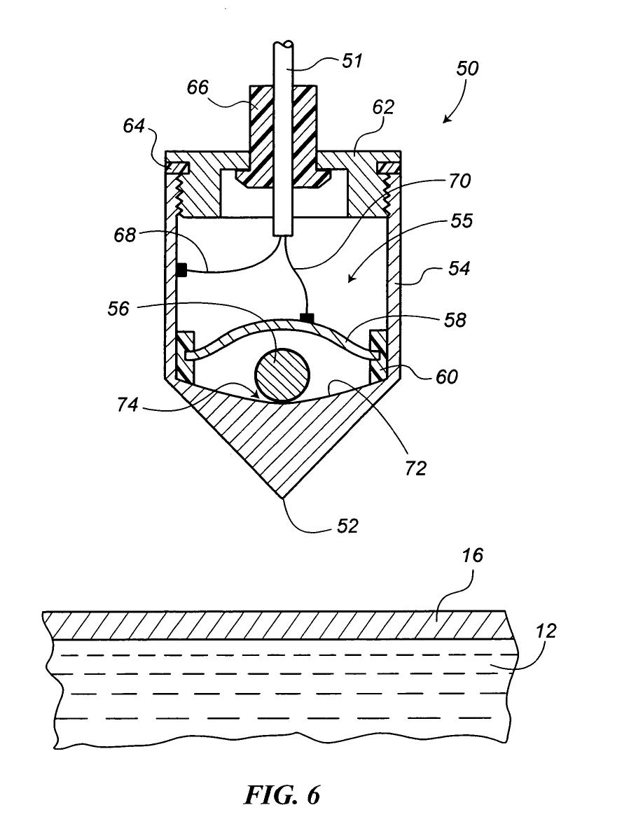

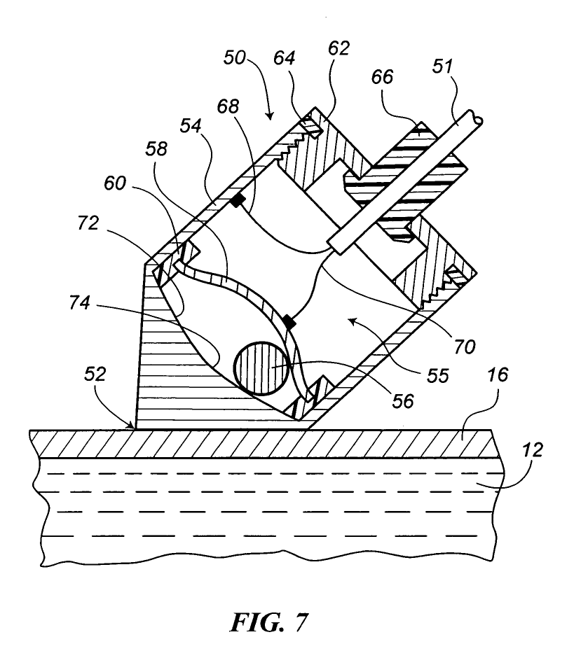

In another embodiment illustrated in FIG. 4, the high-level monitor system 18′ uses a tilt switch 50 to determine when the tank roof 16 has reached the high-level. In this embodiment, the tilt switch 50 is suspended vertically above the roof 16 of the tank 10 by a cable 51. The tilt switch 50 hangs substantially vertical as the cable 51 remains taut, i.e. when the cable 51 supports the weight of the switch 50. As the tank 10 fills with fluid 12, raising the roof 16, the roof 16 will contact a pivot point 52 of the switch housing 54 at some predetermined level. As the roof 16 continues to rise, the tilt switch 50 will begin to tilt about the pivot point 52, as illustrated in FIG. 5. At some degree of tilt, the tilt switch 50 will go from an open condition (see FIG. 6) to a closed condition (see FIG. 7) and close an electrical circuit 55. In an embodiment, the switch housing 54 will be brass or other non-sparking electrically conducting material to prevent sparks when the roof 16 contacts the switch housing 54 because the tilt switch 50 may be used in hazardous environments.

In an embodiment, as is shown in FIGS. 6 and 7, the tilt switch 50 may be a ball bearing switch. The tilt switch 50 generally includes the switch housing 54, a ball bearing 56, a contact plate 58, a contact plate mount 60, a cap 62, a seal 64, and a rubber grommet 66.

The ball bearing 56 either opens or closes the electrical circuit that passes through the switch housing 54 and contact plate 58. The switch portion of the electrical circuit includes a first electrical lead 68 connected to the switch housing 54, the ball bearing 56, and a second electrical lead 70 connected to the contact plate 58. The first and second electrical leads 68, 70 are connected to the monitor 28. The electrical leads 68 and 70 may pass through the cable 51, but preferably are not used to support the switch 50. When the ball bearing 56 electrically connects the switch housing 54 to the contact plate 58, the tilt switch 50 is in a closed condition and electricity may pass through the completed circuit. When the ball bearing 56 does not electrically connect the switch housing 54 to the contact plate 58, the tilt switch 50 is in an open condition and electricity may not pass through the broken circuit.

In the open condition, as illustrated in FIG. 6, the cable 51 suspends the tilt switch 50 vertically above the roof 16. The bottom interior surface 72 of the switch housing 54 is concave or dished such that when the tilt switch 50 hangs vertically, i.e. in an untilted position, the ball bearing 56 settles in a low point 74 of the bottom surface 72, typically the center, preventing the ball bearing 56 from electrically connecting the switch housing 54 to the contact plate 58.

As the fluid level rises and raises the roof 16 to the high-level, the root 16 lifts the tilt switch 50 causing it to tilt about pivot point 52, as illustrated in FIGS. 5 and 7. As the tilt switch 50 tilts, the ball bearing 56 rolls out of the low point 74 toward a side of the switch housing 54. At some point, the ball bearing 56 contacts the contact plate 58 and the bottom interior surface 72, thereby, electrically connecting the contact plate 58 to the switch housing 54 to complete the electrical circuit.

The contact plate mount 60 secures the contact plate 58 to the switch housing 54 while insulating the contact plate 58 from the switch housing 54. The contact plate mount 60 may be any insulating material and is preferably rubber or plastic. The insulating material prevents short circuiting between the contact plate 58 and the switch housing 54.

For high-level monitoring systems 18′ that use a low current, battery powered monitor 26 and/or current source, the ball bearing 56, contact plate 58, and bottom interior surface 72 are plated or made of highly conductive metals such as gold. Furthermore, the interior of the switch housing 54 may be filled with an inert gas and hermetically sealed to further facilitate low current applications and prevent corrosion. The seal 64 and rubber grommet 66 facilitate hermetically sealing the cable 51 and cap 62 relative to the switch housing 54.

The present invention is illustrated and described with reference to a ball bearing tilt switch. However, the present invention is not limited to ball bearing tilt switches and may include other tilt type switches such as mercury switches, mechanical switches, magnetic reed switches, switches incorporating a pendulum, micro-switches, rolling ball bearing activated micro-switches, and the like. In an alternative embodiment, all appropriate electrical contacts and switch components in the switch is preferably configured for low current applications.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A level monitoring system for a tank having a floating roof. the level monitoring system comprising:
a switch having a biasing means for applying a first force on the switch to bias the switch to a first state;
a counter load operatively coupled to and adapted to be suspended from the switch, the counter load acting on the switch with a second force opposite the first force to bias the switch to a second state;
a monitor electrically connected to the switch; and
wherein the second force is greater than the first force when the floating roof is below a predetermined level, and wherein the first force is greater than the second force when the floating roof is at least equal to the predetermined level.

2. The level monitoring system of claim 1, further comprising an alarm module in communication with the monitor.

3. The level monitoring system of claim 2, wherein the monitor wirelessly communicates with the alarm module.

4. The level monitoring system of claim 1, wherein the monitor is battery powered.

5. The level monitoring system of claim 4, wherein switch includes gold electrical contacts.

6. The level monitoring system of claim 1, wherein the counter load is a weight that is hangs freely over the floating roof.

7. The level monitoring system of claim 6, wherein the weight comprises brass.

8. The level monitoring system of claim 1, wherein the first state of the switch is open and wherein the second state of the switch is closed.

9. A level monitoring system for a tank having a floating roof the level monitoring system comprising:
a monitor;
a tilt switch assembly operatively coupled to and adapted to be suspended from the monitor, the tilt switch having a housing that defines a pivot point at one end thereof and a switch positioned within the housing; and
wherein the tilt switch assembly is in a first state when the floating roof is below a predetermined level, and wherein the wherein the tilt switch is in a second state when the floating roof is at least equal to the predetermined level.

10. The level monitoring system of claim 9, wherein the monitor communicates with an alarm module.

11. The level monitoring system of claim 10, wherein the alarm module is remotely located from the monitor, and wherein the monitor wirelessly communicates with the alarm module.

12. The level monitoring system of claim 9, wherein the monitor is battery operated.

13. The level monitoring system of claim 12, wherein the tilt switch includes a pair of electrical contacts comprising gold.

14. The level monitoring system of claim 9, wherein the tilt switch is a ball bearing tilt switch.

15. The level monitoring system of claim 1, wherein the housing of the tilt switch assembly comprises a non-sparking material.

16. The level monitoring system of claim 15, wherein the housing is filled with an inert gas.

17. A level monitoring system for a tank having a floating roof, the level monitoring system comprising:
a monitor;
a body;
suspension means coupled to the body for suspending the body above the floating roof;
wherein the body is movable between a first position where it is fully supported by the suspension means and a second position where it is not fully supported by the suspension means; and
a switch electrically connected to the monitor, the switch being in a first state when the body is in the first position and in a second state when the body is in the second position.

18. The level monitoring system of claim 17, wherein the switch is integral with the hanging body.

19. The level monitoring system of claim 18, wherein the switch is a tilt switch.

20. The level monitoring system of claim 17, wherein the body hangs from the switch by the suspension means, the switch further including biasing means for biasing the switch in a direction opposite the suspension means.
